(19) United States
(12) Patent Application Publication
(10) Pub. No.: US 2019/0320613 A1
(43) Pub. Date: Oct. 24, 2019

(54) PET PROTECTIVE TRANSPORT ARRANGEMENT

(71) Applicant: MIM CONSTRUCTION AB, Frandefors (SE)

(72) Inventor: Mats BJÖRNETUN, Frandefors (SE)

(21) Appl. No.: 16/348,640

(22) PCT Filed: Nov. 13, 2017
(86) PCT No.: PCT/SE2017/051121

§ 371 Date: May 9, 2019

(30) Foreign Application Priority Data
Nov. 18, 2016 (SE) 1651516-5

(51) Int. Cl. A01K 1/02; A01K 1/00

(52) U.S. Cl. CPC A01K 1/0272; A01K 1/0064; A01K 1/029; A01K 1/0245

(57) ABSTRACT

This invention relates to a safety pet transportation device, basically in the form of a portable cage, comprising a main body, two oppositely attached side walls, at least one door, a handle and at least one safety arrangement, said main body having a bottom part, a top part with said handle and a front and a back part, wherein at least on of said front and a back part is arranged with one opening for attachment of said at least one door, and wherein, at least one of said side walls having a peripheral solid body part arranged with a plurality of safety belt holders.

### TECHNICAL FIELD

This invention relates to a safety pet transportation device, basically in the form of a portable cage, wherein at least one part is arranged with one opening for attachment of a door, and wherein safety belt holders are arranged to facilitate securing of the device in a vehicle.

### BACKGROUND

Safety has been more and more focused in connection with transportations. For human beings, significant improvements have been achieved the recent decades. Regarding pets, there has also been significant development. However, most safety measures of today are relatively cumbersome to utilise regarding pets of some size, e.g. dogs and cats. Mostly it requires quite a lot of handcraft to assemble existing safety devices. Accordingly, there is a need for improvement to more easily facilitate safe transport of pets.

Document US2016057968 discloses a versatile pet transporter which can be wheeled, carried by hand, or restrained on a car seat. The handle for wheeling is telescopic, retractable, and recessed when not in use, obviating any danger from the handle in a car. Seat belts pass through six different flanges, anchoring the transporter to a car seat in all directions. The transporter may be fitted with a litter box and readily replaceable litter packages, a fan, sound monitoring, and other features.

Document US2003127060 discloses a pet carrier having series of interconnected panels and removable stiffening members forming a flexible pet enclosure that can be carried by a pet owner or secured in a vehicle for transport. As the support members are semi-rigid, the roof of the enclosure may be resiliently deformed as needed, such as for placing the carrier under a passenger airline seat. Removal of the support members allows a user to collapse the pet carrier to a substantially flat configuration. The pet carrier may be carried by a pet owner via a six-point shoulder strap system that is capable of levelling the carrier during use. The pet carrier also has several openings to provide ventilation and a compartment that communicates with the inside of the carrier for inserting an air conditioning pad.

### SUMMARY OF THE INVENTION

It is an object of the invention to improve on the above described situation, which is achieved by means of pet protecting transport arrangement according to the claims.

Thanks to the invention, a very easily handled safety arrangement is achieved that saves time and makes it much easier for the pet owner to arrange for a safe transport. Furthermore, it also will enable a more comfortable situation for the pet.

According to further preferred aspects of the invention;
There are arranged a plurality of safety belt holders including four of said safety belt holders, two positioned adjacent each one of two lower corners areas and two positioned adjacent each one of two upper corners areas, which provides the advantage that increased flexibility is achieved.
said plurality of safety belt holders are positioned symmetrically in relation to a vertical center line of said side wall, and the lower safety belt holders extend substantially vertical and the upper safety belt holders extend at an angle in relation to the vertical, wherein preferably the angle is between 120° to 150°, which provides the advantage that increased flexibility is achieved in combination with extra ease of use.
the peripheral solid body part, where the safety belt holders are arranged, has a generally convex form, which provides the advantage that increased ease of use is achieved and better strength properties.
two identical side walls are attached to the main body to form the device, which provides the advantage that even more increased flexibility is achieved and cost-efficiency.
The main body is symmetrically formed in relation to a vertical line and preferably that said front and a back part include differently angled portions, which provides for cost-efficiency and the further advantage that sharp corners are eliminated.
a centre portion of a wall is arranged with the opening for a door and wherein preferably said center portion is substantially flat and extending mainly vertically but with an angle in relation to the vertical to make said at least one door leaning inwards to the centre of the cage, which provides the advantage that cost-efficiency may be achieved, good adaption to a car seat and that a door will be urged in a closing direction by gravity.
said main body is arranged with reinforcing members that preferably also are used for screw attachments, which provides the advantage that reinforcements are easily produced in a cost-efficient manner, e.g. extruding.
a major portion of said at least one door comprises a grating (41), which provides beneficial ventilation of the device.
The handle is positioned a distance off-centered in relation to a longitudinal center plane, which provides the advantage that the device is easier to carry.

### BRIEF DESCRIPTION OF THE FIGURES

In the following, the invention will be described in more detail regarding the enclosed figures, wherein;

FIG. 1 shows a perspective view from above of a preferred embodiment according to the invention,

FIG. 2 shows a perspective view seen from below of the safety device in FIG. 1,

FIG. 3 shows a side view of the safety device in FIG. 1,

FIG. 4 shows a cross-sectional view in perspective from above of a device shown in FIG. 1,

FIG. 5 shows a front view the safety device in FIG. 1,

FIG. 6 shows a corner portion of a cross-sectional horizontal view in a plane through the centre of the safety device in FIG. 1, and,

FIG. 7 shows a corner portion of a cross-sectional vertical view of the safety device in FIG. 1.

### DETAILED DESCRIPTION

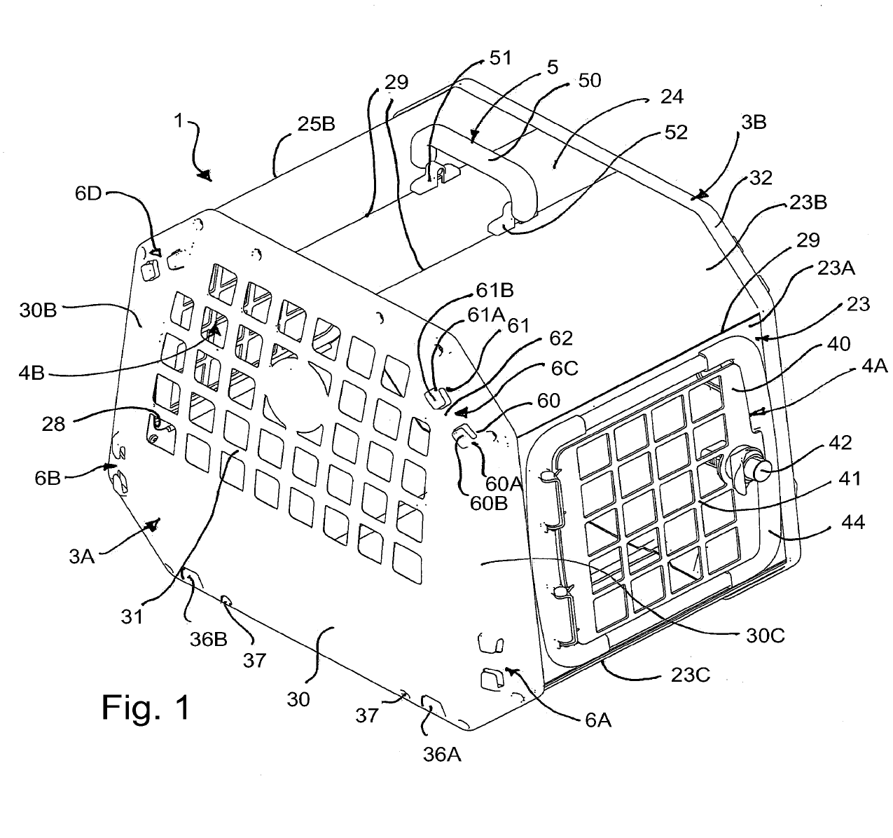

In FIG. 1 there is shown a protective transport device 1 according to the invention, seen in a perspective view from above. In general, the protective transport device 1 comprises a generally tube formed main body 2, a left-hand side wall 3A, and a right-hand side wall 3B, generally forming a cage. On the front and back parts 23, 25 of the main body 2 there are arranged openings 28 having doors 4A, 4B fit thereto. Further, there is a carrying handle 5 arranged on the top part 24 of the main body 2. Preferably the main body is built from several extruded parts (see FIG. 7) that are slid together presenting a joint 29 at the exterior, which joint preferably is pivot able as will be explained more in detail below. Moreover, there is also a safety arrangement 6A-6D arranged on each one of the side walls 3A, 3B.

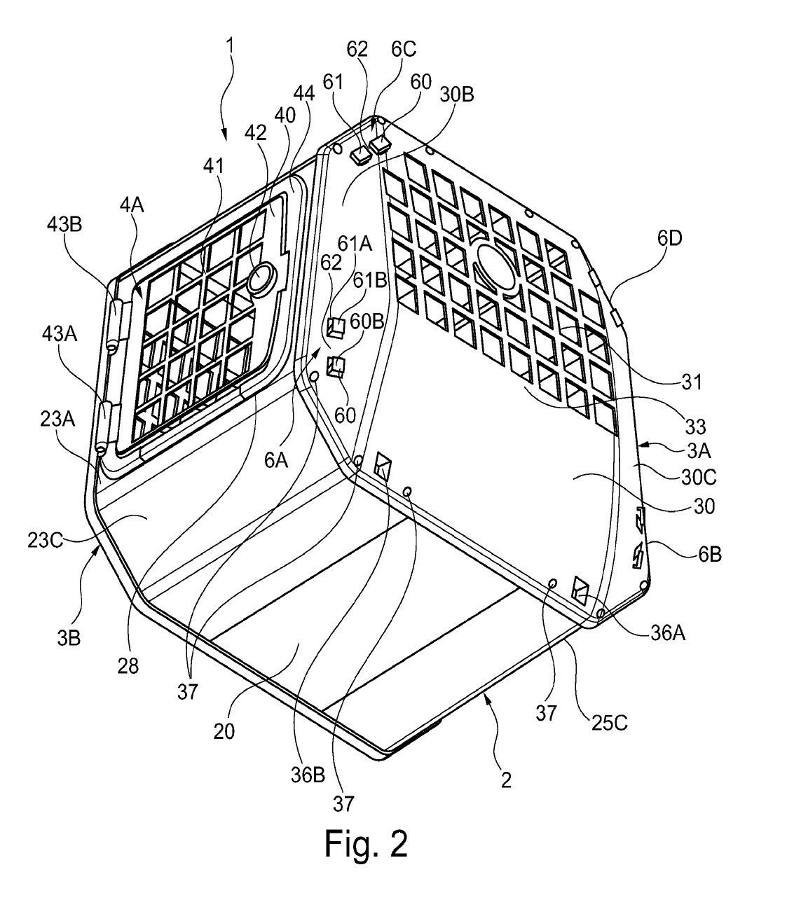

The main body 2 comprises a substantially flat top part 24 and a parallel substantially flat bottom part 20 (see FIG. 2). To avoid sharp corners, the top part 24, bottom part 20 and front/back parts 23, 25 are joined by means of angled, interconnecting portions 23B, 23C, 25B, 25C, preferably the angle β is in the range of 30°-60°. The main body 2 is symmetric in relation to a vertical plane passing through a vertical centre line C thereof, but not symmetric in relation to a horizontal plane passing through the centre thereof.

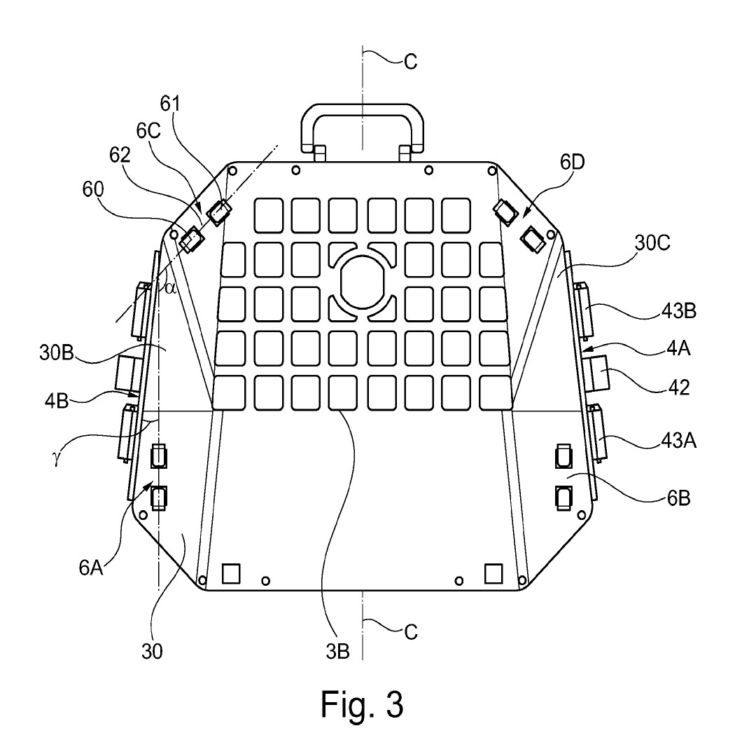

As is evident when looking at FIG. 3, the front side 23 and back side 25 do present an angle γ in relation to a vertical line. Thanks to the inward inclination γ of the side walls 23, 25, the doors 4A, 4B will be affected by a momentum (when opened), which urges the door 4A, 4B in a closing direction thanks to the gravitational force acting thereof, which is an advantage in many situations. A further reason for this inclination is that the cage 1 will then mostly be better adapted to fit into a seat in a car.

FIG. 3 more clearly presents that the transition parts 23B, 23C, 25B, 25C of the side walls 23, 25 may present an angle of about 45° in relation to the vertical line, which provides the advantage that no very sharp angles are formed.

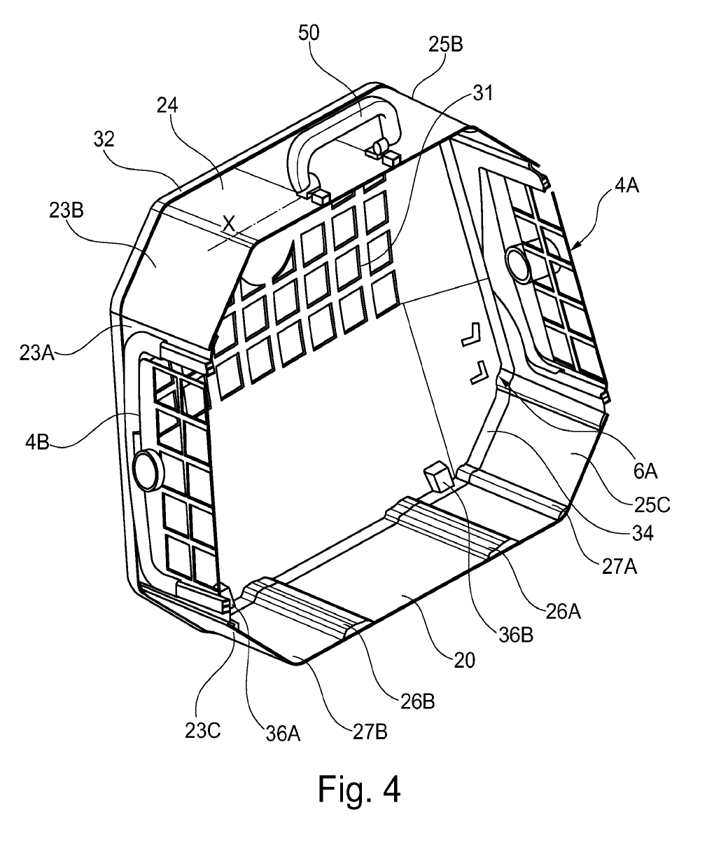

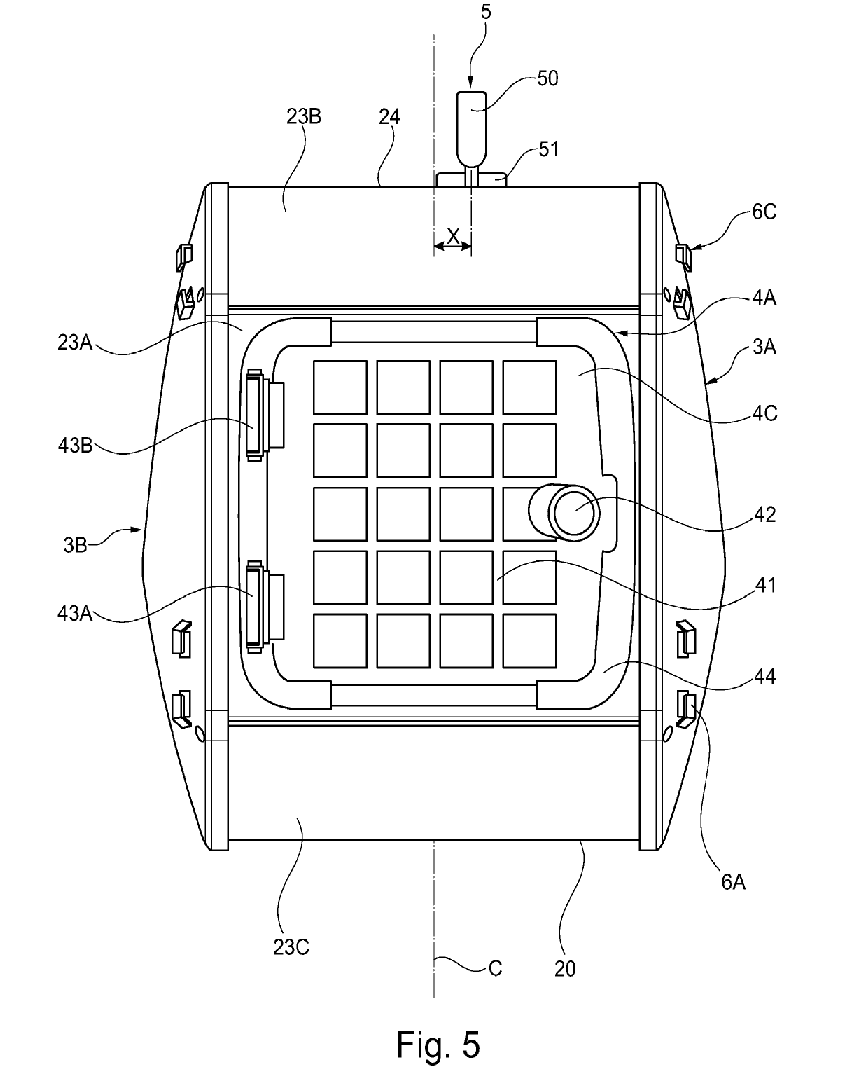

As seen in FIG. 4, the main body 2, at different positions, is arranged with reinforcing ribs 26A, 26B, 27A, 27B. These ribs also serve the purpose of anchoring means for screws 37 that are used to attach the side walls 3A, 3B. Furthermore, some of these ribs 26A preferably are in the form of an assembly of two interconnecting members 26A′, 26A″ of neighbouring parts 28A, 28B (see FIG. 7) that form the main body 2. Preferably these interconnecting members 26A′, 26A″ form a joint 9 that is pivotable in one direction, i.e. such that they cannot collapse/pivot inwardly, but outwardly, which provides the advantage that the cage 1 may interact with a compression zone of a vehicle. For instance, if the cage 1 is positioned in a small car, exactly fit in behind the driver seat, with one its door facing the back of the driver seat, the main body may easily be compressed in a crash, such that it may not cause extra resistance that otherwise could cause neck injuries to the driver.

The two side walls 3A, 3B are exactly the same and as a consequence to fit with the main body, each side wall 3A, 3B is symmetric in relation to a vertical centre plane. The side walls have a grating 31 that covers more than 50% of the total area of each side wall 3A, 3B, which grating 31 is surrounded by a homogenous supporting part 30. Also, the side walls 3A, 3B present angled portions 30B, 30C preferably in the range of 30°-60° in connection with the transfer zone to the front and back walls 23, 25. A reason for these angled walls 30B, 30C is the same as for the angled parts 23B, 23C, 25B, 25C of the main body 2, i.e. to avoid sharp cone corners. Also, these angled portions 30B, 30C are preferably positioned such that they protrude about 45° in relation to the main extension of the side walls.

In these angled portions 30B, 30C, which preferably coincide to present a homogenous strong peripheral part 30 of a side wall 3A, 3B, the safety transportation devices 6A-6D are arranged. Each one of these safety devices are in the form of two L-shaped protruding members 60, 61 presenting a first part 61A (see FIG. 2) of the L that is substantially flat-formed and protrudes about 2-8 mm out from the side wall and a second part 61B presenting the foot of the L pointing in a direction towards each other, but not contacting each other. The flat-shaped foot parts 61B, 60B protrude such that their flat surfaces are parallel to each other.

Accordingly, they will create an opening 62 in between the ends of the foot parts and jointly form a retaining device for a safety belt (or the like). Hence, a safety belt that is flexible, may easily be introduced into the gap 62 and moved in under one of the foot parts 61B, 60B and then the other side of the belt may be pushed into the gap 62 to be withheld by the second L-shaped member 60. Thereby a safe retaining will be achieved of a belt (not shown) introduced therein. On each side wall 3A, 3B there are four such safety devices 6A-6D arranged.

Two of these safety devices 6A, 6B are arranged adjacent the bottom 20 near each one of the lower corners. These two devices 6A, 6B have an extension of the foot parts 60B, 61B that substantially extends in a vertical direction. The two others 6C, 6D are positioned adjacent the top part 24 near each one of the upper corner and have their foot parts 60B, 61B extending in a direction that presents an angle α in relation to a vertical line. The angle α will be in the range of 120°-150°, preferably about 135° in relation to the vertical line, implying approximately 45° in relation to the horizontal line. Thanks to this positioning each front side will enable easy fixation of a three-point safety belt to the safety transportation arrangement 1 according to the invention. Thanks to the symmetric disposition of the safety devices 6A-6D it will not make any difference if the transportation device 1 is turned one or the other way, nor if it is put in a left-hand seat or in a right-hand seat. The arrangement of the safety devices will always enable safe fixation of the safety transportation device 1.

Further, it is shown in FIG. 3 and FIG. 2 that the widest horizontal cross-section enclosed by the space formed between the side walls 3A, 3B is positioned slightly below the horizontal centre of the transport device, which brings about the advantage that more space is available at the lower part, and also that the part 31 arranged with the grating may be substantially flat-shaped which reduces the risk of hooking into things with the grating 31.

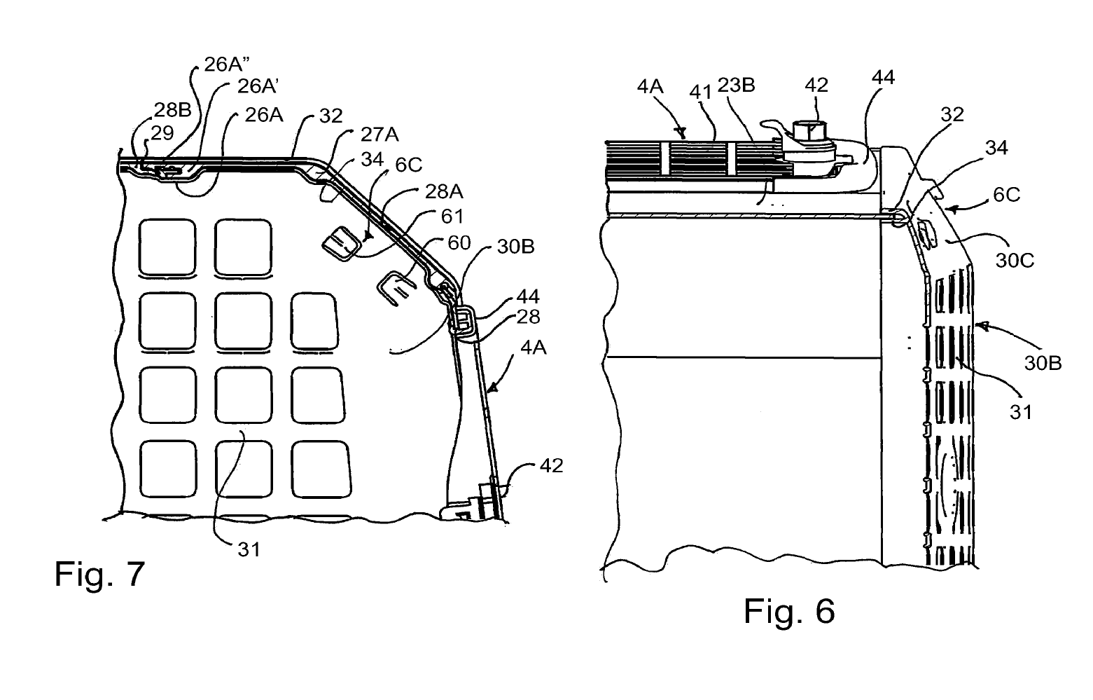

The attachment of the side walls 3A, 3B to the main body 2 has already been indicated above, i.e. that screws 37 are used to safely attach the side walls to the main body 2. Furthermore, it is clear from the figures, e.g. FIGS. 4, 6 and 7, that flanges 32 and 34, are used to securely attach the side walls 3A, 3B to the main body 2. These flanges 32, 34 protrude on each side of the surfaces of the main body 2 and accordingly they securely fixate the main body 2 in all directions. Moreover, there is shown, see FIGS. 2 and 4, that there are indentations 36B arranged in the lower part of the side walls that coincide with the inner flange 34, which indentations 36A, 36B have the purpose of providing grips for safe attachment of the cage 1 in a vehicle equipped with corresponding male grip members (not shown).

The doors 4A, 4B are pre-fixed in frames 44 that are adapted to be attached to corresponding openings in the side walls 23, 25 of the main body 2. Further, there is arranged a door 40, having hinges 43A, 43B and an opening knob 42. The major part of each door 4A, 4B is arranged with a grating 41.

On top of the top part 24 of the main body 2 there is arranged a handle 5. The handle comprises a gripping part 50 and an attachment part 51. The attachment part 51 is positioned at a distance X away from a centre line C of the main body, which provides the advantage that the transportation device 1 may be more easily carried by a person

1. A safety pet transportation device, basically in the form of a portable cage, comprising a main body, two oppositely attached side walls, at least one door, a handle and at least one safety arrangement,
said main body having a bottom part, a top part with said handle and a front and a back part, wherein at least on of said front and a back part is arranged with one opening for attachment of said at least one door, and wherein, at least one of said side walls having a peripheral solid body part arranged with a plurality of safety belt holders, said plurality of safety belt holders include four of said safety belt holders, two positioned adjacent each one of two lower corners areas and two positioned adjacent each one of two upper corners areas such that said plurality of safety belt holders are positioned symmetrically in relation to a vertical center line of said side wall, and the lower safety belt holders extend substantially vertical and the upper safety belt holders extend at an angle (α) in relation to the vertical, wherein preferably 120°<α<150°.

2. A safety pet transportation device, according to claim 1, wherein said peripheral solid body part has a generally convex form.

3. A safety pet transportation device, according to claim 1, wherein two identical side walls are arranged.

4. A safety pet transportation device, according to claim 1, wherein said main body is symmetrically formed in relation to a vertical line and that said front and a back part include differently angled portions.

5. A safety pet transportation device, according to claim 4, wherein a centre portion is arranged with said opening and wherein preferably said center portion is substantially flat and extending mainly vertically but with an angle (γ) in relation to the vertical to make said at least one door leaning inwards to the centre of the cage.

6. A safety pet transportation device, according to claim 4, wherein said main body is arranged with reinforcing members that preferably also are used for screw attachments.

7. A safety pet transportation device, according to claim 1, wherein a major portion of said at least one door comprises a grating.

8. A safety pet transportation device, according to claim 1, wherein said handle is positioned a distance off-centered in relation to a longitudinal center plane.
